(19) United States
(12) Patent Application Publication
(10) Pub. No.: US 2008/0088098 A1
(43) Pub. Date: Apr. 17, 2008

(54) Combination of driving tool and chuck key

(76) Inventor: Tien Kuei Hsu, Changhua City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/730,779

(22) Filed: Apr. 4, 2007

(30) Foreign Application Priority Data
Oct. 11, 2006 (TW) 095137393

(51) Int. Cl. B23B 5/34

(52) U.S. Cl. 279/149

(57) ABSTRACT

A chuck locking and unlocking assembly includes a chuck key which has a shank with a tapered toothed surface defined in a first end thereof and a connection end is connected to a second end of the shank. A driving tool has a handle and a head in which a cooperation member is rotatably connected. The cooperation member is removably connected to the connection end of the chuck key and the user rotates the handle of the driving tool to rotate the chuck key so as to lock or release the bit clamp by the chuck.

### FIELD OF THE INVENTION

The present invention relates to a driving tool and a chuck key which is driven by the driving tool so as to easily lock and unlock the chuck of an electric drill tool or manual drill tool.

### BACKGROUND OF THE INVENTION

A conventional way to lock or unlock a chuck 8 of an electric drill tool or manual drill tool is to use a chuck key 7 as shown in FIG. 5, wherein the chuck 8 includes a recess 821 defined in an outer periphery of the cylindrical body 82 of the chuck and a toothed surface 822 is formed on a surface of a base portion. Three pawls 81 are opened from each other to release a bit or moved toward each other to clamp a bit (not shown) by rotating the base portion in which a mechanism (not shown) drives the three pawls 81. The conventional chuck key 7 includes a shank 72 with a tapered toothed surface 71 and a central protrusion 711 is located at a front end of the tapered toothed surface 71. A handle 721 is connected perpendicularly to the shank 72 and an assist tube 722 can be used to prolong the arm of force when rotating the chuck key 7 by connecting the assist tube 722 to the handle 721. The central protrusion 711 is inserted into the recess 821 and the tapered toothed surface 71 is engaged with the toothed surface 822 of the chuck 8, when rotating the shank 72, the base portion of the chuck 8 is rotated so as to drive the pawls 81 to lock or release the bit. The user has to hold the short assist tube 722 and applies a torque to the shank 72, and this process sometimes is difficult especially when a huge torque is required.

FIG. 9 shows another way to drive the chuck key 9 which includes a shank 92 with a tapered toothed surface 91 at a first end thereof and a central protrusion 911 is located at a front end of the tapered toothed surface 91. A polygonal rod 921 extends from a second end of the shank 92 so as to be engaged with a driving tubular member 931 of a pneumatic driving tool 93. However, the polygonal rod 921 has its own specification so that the size of the driving tubular member 931 of the pneumatic driving tool 93 has to be purchased individually.

The present invention intends to provide a driving tool for operating the chuck key and the driving tool is a handle tool which is easily to be carried and requires no electric power.

### SUMMARY OF THE INVENTION

The present invention relates to a chuck locking and unlocking assembly which comprises a chuck key having a shank with a tapered toothed surface defined in a first end thereof and a connection end is connected to a second end of the shank. A central protrusion extends from a center of the tapered toothed surface. A driving tool has a handle and a head is connected to one end of the handle. A grasp is connected to the other end of the handle. The head has a cooperation member connected thereto which is removably connected to the connection end of the chuck key.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the chuck, the driving tool and the chuck key of the present invention;

FIG. 2 shows the chuck key in FIG. 1 of the present invention;

FIG. 3 is an exploded view to show a second embodiment of the driving tool and the chuck key of the present invention;

FIG. 4 is an exploded view to show a third embodiment of the driving tool and the chuck key of the present invention;

FIG. 5 is an exploded view to show a conventional chuck, the driving tool and the chuck key, and

FIG. 6 shows a second embodiment of the conventional chuck, the driving tool and the chuck key.

### DETAILED DESCRIPTION OF THE PREFERRED EMBODIMENT

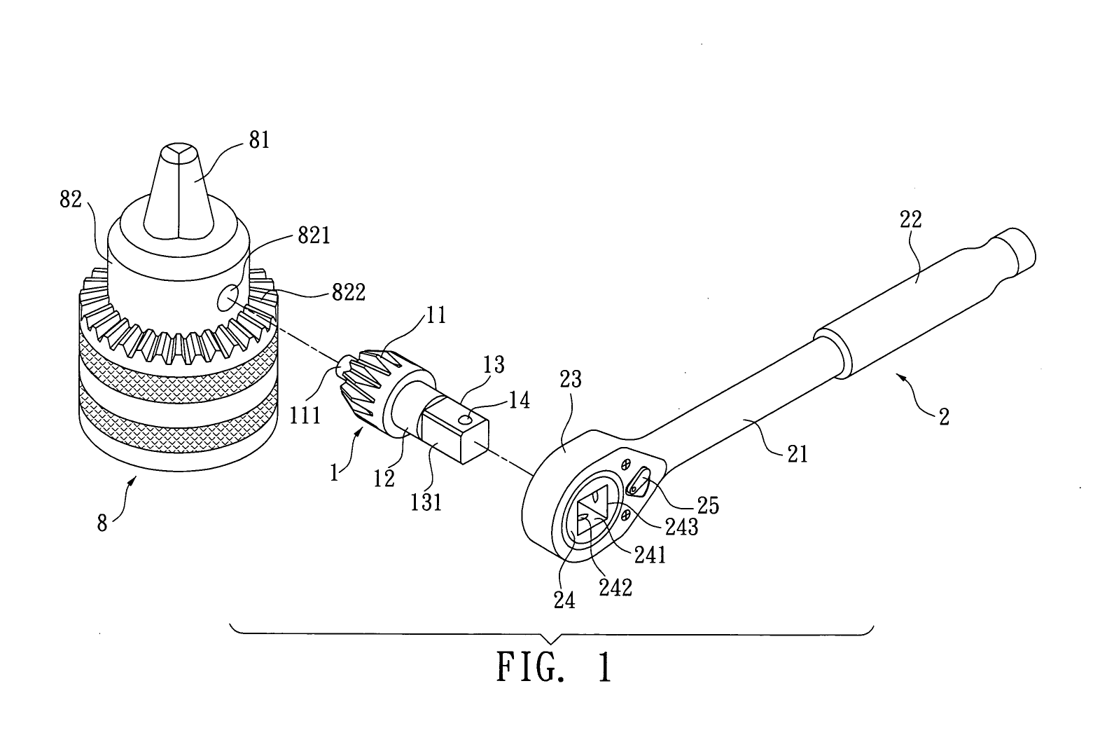

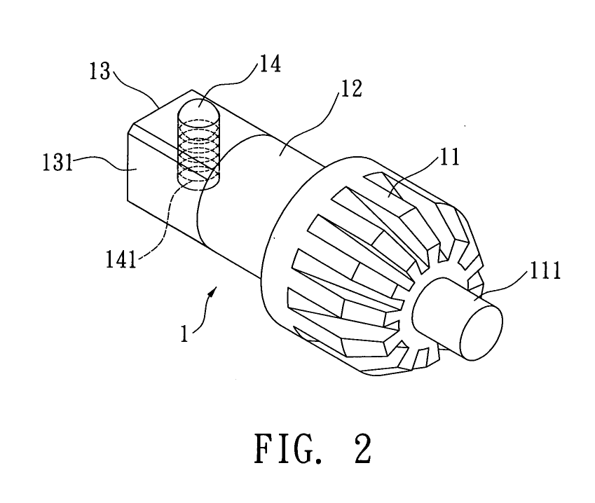

Referring to FIGS. 1 and 2, the chuck locking and unlocking assembly of the present invention comprises a chuck key 1 and a driving tool 2 wherein the chuck key 1 includes a shank 12 with a tapered toothed surface 11 defined in a first end thereof and a central protrusion 111 extends from a center of the tapered toothed surface 11. A connection end 13 is connected to a second end of the shank 12 and includes four sides 131. One of the four sides 131 includes a bead 14 biased by a spring 141 received in the connection end 13, A part of the bead 14 retractably protrudes from the side 131.

The driving tool 2 has a handle 21 and a head 23 is connected to one end of the handle 21 and a grasp 22 is connected to the other end of the handle 21. The head 23 has a cooperation member 24 rotatably received therein and is controlled by a ratchet mechanism (not shown) which is controlled by a lever 25 on a side of the head 23. The cooperation member 24 includes a polygonal through hole 243 with which the connection end 13 is engaged. Each inside 241 defining the polygonal through hole 243 has a notch 242 defined therein which is sized to receive the bead 14. The connection end 13 is engaged with the polygonal through hole 243 and the central protrusion 111 is rotatably inserted into the recess 821 in the cylindrical body 82 of the chuck 8 and the tapered toothed surface 11 is engaged with the toothed surface 822 of the chuck 8. When rotating the shank 12, the base portion of the chuck 8 is rotated so as to drive the pawls 81 to lock or release the bit which is not shown.

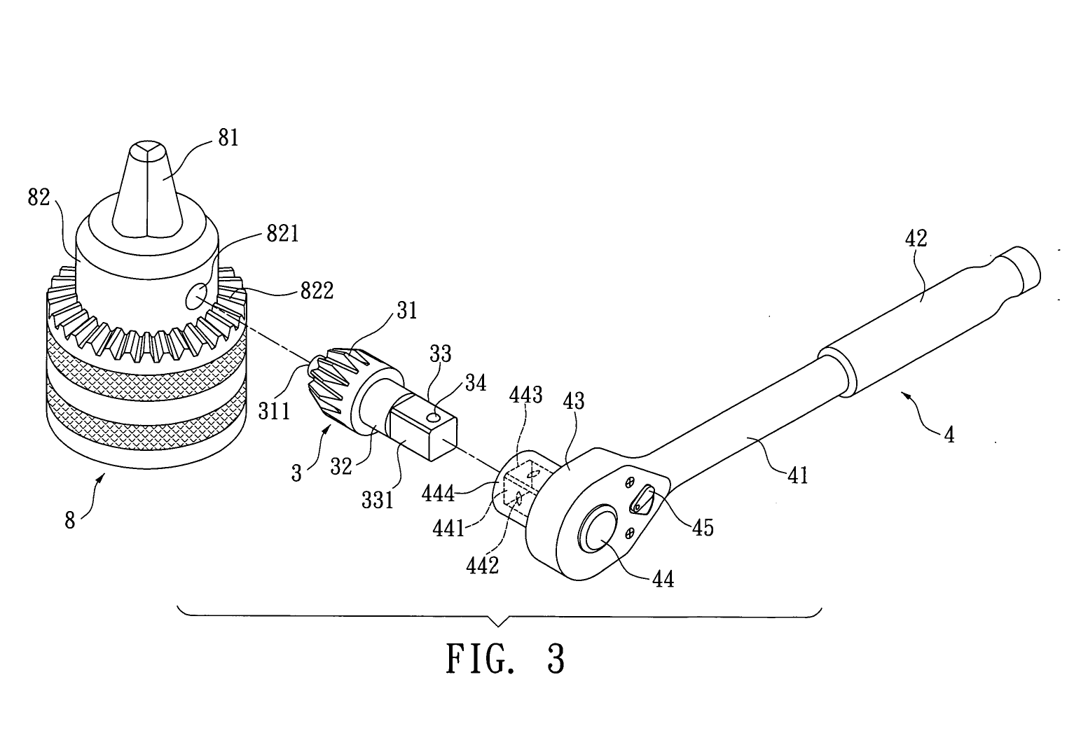

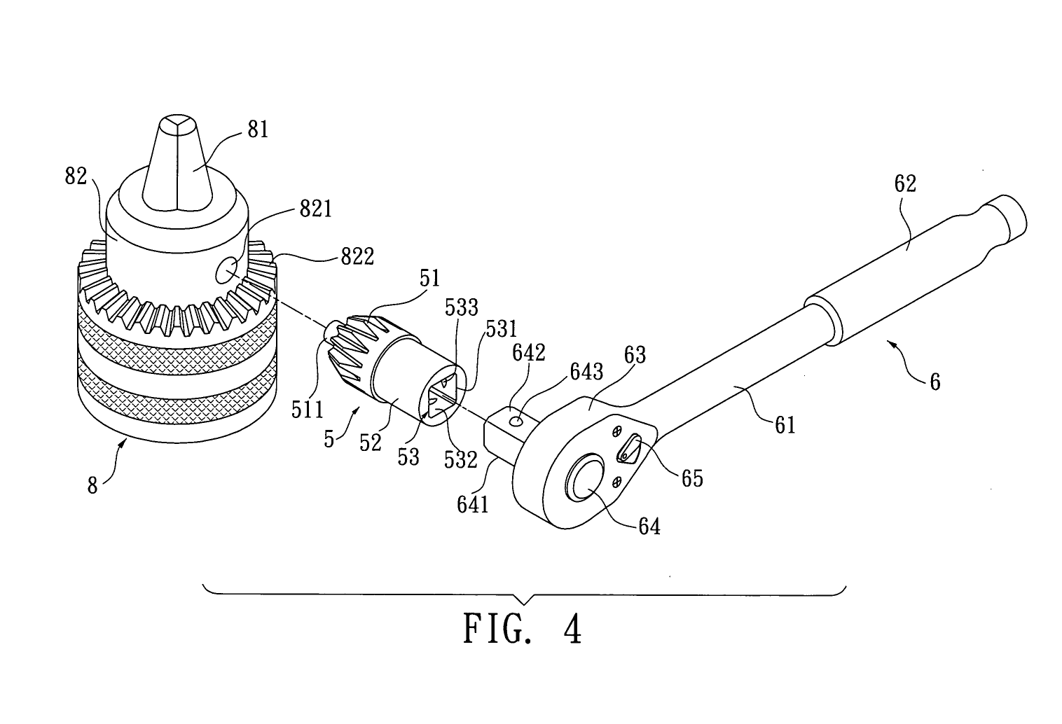

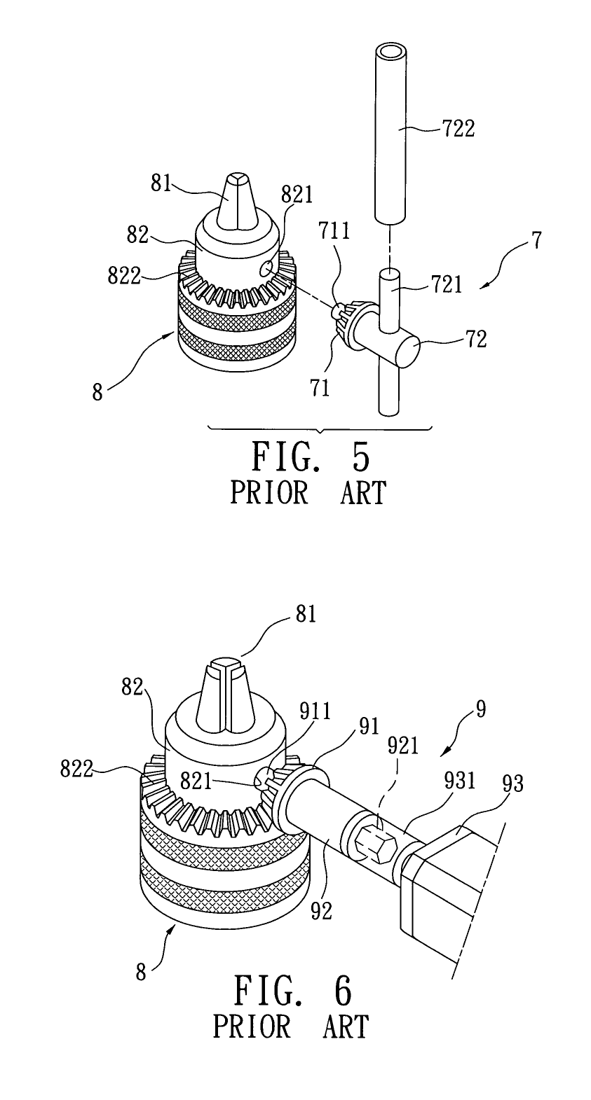

FIG. 3 shows a second embodiment of the driving tool 4 and the chuck key 3 of the present invention wherein the chuck key 3 is the same as disclosed in FIGS. 1 and 2. The chuck key 3 in the second embodiment includes a shank 32 with a tapered toothed surface 31 defined in a first end thereof and a central protrusion 311 extends from a center of the tapered toothed surface 31. A connection end 33 is connected to a second end of the shank 32 and includes four sides 331. One of the four sides 331 includes a bead 34 biased by a spring received in the connection end 33. The driving tool 4 has a handle 41 and a head 43 is connected to one end of the handle 41 and a grasp 42 is connected to the other end of the handle 41. The head 43 has a cooperation member 44 rotatably connected thereto and is controlled by a ratchet mechanism (not shown) which is controlled by a lever 45 on a side of the head 43. The cooperation member 44 includes a tubular member 444 extending from a side of the head 43 and a recess 443 is defined in a distal end of the tubular member 444. Each inside 441 defining the recess 443 has a notch 442 defined therein which is sized to receive the bead 34.

FIG. 3 shows a third embodiment of the driving tool 6 and the chuck key 5 of the present invention wherein the chuck key 5 includes a shank 52 with a tapered toothed surface 51 defined in a first end thereof and a central protrusion 511 extends from a center of the tapered toothed surface 51. A connection end 53 is connected to a second end of the shank 12 and has an engaging port 531. Each inside 532 defining the engaging port 531 having a notch 533 defined therein.

The driving tool 6 has a handle 61 and a head 63 is connected to one end of the handle 61 and a grasp 62 is connected to the other end of the handle 61. The head 63 has a cooperation member 64 rotatably connected thereto which includes a driving rod 641 which includes four sides 642 and one of the sides 642 has a bead 643 connected thereto which is engaged with one of the notches 533 of the engaging port 531.

While we have shown and described the embodiment in accordance with the present invention, it should be clear to those skilled in the art that further embodiments may be made without departing from the scope of the present invention.

What is claimed is:

1. A chuck locking and unlocking assembly comprising:
a chuck key having a shank with a tapered toothed surface defined in a first end thereof and a central protrusion extending from a center of the tapered toothed surface, a connection end connected to a second end of the shank, and
a driving tool having a handle and a head connected to one end of the handle and a grasp connected to the other end of the handle, the head having a cooperation member connected thereto, the cooperation member removably connected to the connection end of the chuck key.

2. The assembly as claimed in claim 1, wherein the cooperation member is rotatably received in the head and includes a polygonal through hole with which the connection end is engaged.

3. The assembly as claimed in claim 2, wherein the connection end includes a plurality of sides and one of the sides includes a bead biased by a spring received in the connection end, each inside defining the polygonal through hole has a notch defined therein which is sized to receive the bead.

4. The assembly as claimed in claim 2, wherein the connection end includes a plurality of sides and one of the sides includes a bead biased by a spring received in the connection end, the cooperation member includes a tubular member extending from a side of the head and a recess is defined in an distal end of the tubular member, each inside defining the recess has a notch defined therein which is sized to receive the bead.

5. A chuck locking and unlocking assembly comprising:
a chuck key having a shank with a tapered toothed surface defined in a first end thereof and a central protrusion extending from a center of the tapered toothed surface, a connection end connected to a second end of the shank and having an engaging port, and
a driving tool having a handle and a head connected to one end of the handle and a grasp connected to the other end of the handle, the head having a cooperation member rotatably connected thereto, the cooperation member including a driving rod which includes a plurality of sides and the driving rod being inserted into the engaging port.

6. The assembly as claimed in claim 5, wherein each inside defining the engaging port has a notch defined therein.

7. The assembly as claimed in claim 6, wherein one of the sides has a bead connected thereto which is engaged with one of the notches of the engaging port.
